(19) United States
(12) Patent Application Publication
(10) Pub. No.: US 2026/0340009 A1
(43) Pub. Date: Oct. 29, 2026

(54) SYSTEM AND METHOD OF PROVIDING STRUCTURED MULTI-AGENT RETRIEVAL-AUGMENTED GENERATION

(71) Applicant: DELL PRODUCTS L.P., Round Rock, TX (US)

(72) Inventors: Maxim Balin, Gan-Yavne (IL); Alexander Molev, Be'er Ya'akov (IL); Adam Terramel Weisbach, Asheville, NC (US)

(21) Appl. No.: 19/190,046

(22) Filed: Apr. 25, 2025

(51) Int. Cl. G06F 16/334; G06N 5/022

(52) U.S. Cl. CPC G06F 16/3344; G06N 5/022

(57) ABSTRACT

A system is provided and includes a computer readable medium having multiple search agents residing thereon. Each search agent is assigned to a particular knowledge domain. The system further includes a processor that is operably coupled to the computer readable medium to access the search agents. The processor receives a user query and route the user query to one or more of the search agents.

### FIELD OF THE DISCLOSURE

The present disclosure generally relates to information handling systems, and more particularly relates to retrieval-augmented generation.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

A system is provided and includes a computer readable medium having multiple search agents residing thereon. Each search agent is assigned to a particular knowledge domain. The system further includes a processor that is operably coupled to the computer readable medium to access the search agents. The processor may receive a user query and route the user query to one or more of the search agents.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a data search and text creation system according to an embodiment of the present disclosure;

FIG. 2 is a block diagram of an information handling system according to an embodiment of the present disclosure;

FIG. 3 and FIG. 4 are a flow diagram of a method of using a structured multi-agent retrieval-augmented generation system to search data; and

FIG. 5 is a block diagram of still another information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

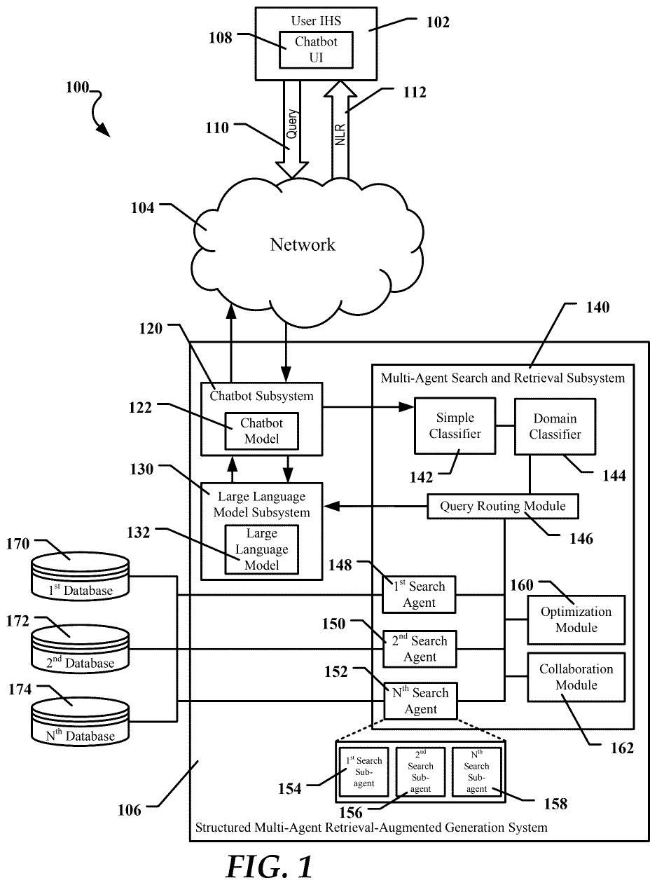

Referring initially to FIG. 1, a data search and text creation system is shown and is generally designated 100. As shown, the data search and text creation system 100 includes a user information handling system (IHS) 102 that is operably coupled to a network 104. The network 104, in turn, is operably coupled to a structured multi-agent retrieval-augmented generation system 106. The user information handling system 102 may include a chatbot user interface (UI) 108 that may be presented at a browser application that executes on the user information handling system 102. During operation, a user may submit a query 110 to the structured multi-agent retrieval-augmented generation system 106 via the chatbot user interface 108 and the network 104. The structured multi-agent retrieval-augmented generation system 106 may execute according to one or more of the steps described herein to quickly and efficiently return a cogent, coherent natural language response 112 that fully and completely answers the query 110 to the chatbot interface 108.

As shown in FIG. 1, the structured multi-agent retrieval-augmented generation system 106 may include a chatbot subsystem 120 in which a chatbot model 122 may reside and execute as described herein. The structured multi-agent retrieval-augmented generation system 106 further includes a large language model subsystem 130 that is operably coupled to the chatbot information handling system 120. A large language model 132 resides and operates on the large language model subsystem 130. FIG. 1 shows that the structured multi-agent retrieval-augmented generation system 106 also includes a multi-agent search and retrieval subsystem 140 that is operably coupled to the chatbot information handling system 120.

As illustrated, the multi-agent search and retrieval subsystem 140 may include a simple classifier 142 operably coupled to a domain classifier 122. The domain classifier 122 is operably coupled to a query routing module 146 that in turn, is operably coupled to a plurality of search agents. Specifically, a first search agent 148, a second search agent 150, and an Nth search agent 152 are operably coupled to the query routing module 146. It is to be understood that three search agents 148, 150, 152 are illustrated for clarity. However, as indicated by the Nth search agent 152, the multi-agent search and retrieval subsystem 140 may include any number of search agents 148, 150, 152 and search agents 148, 150, 152 may be added as needed.

FIG. 1 indicates that each search agent 148, 150, 152 may include a first search sub-agent 154, a second search sub-agent 156, and an Nth search-sub agent 158. For clarity, only the search sub-agents 154, 156, 158 within the Nth search agent 154 are illustrated. It is to be understood that the first search agent 148 and the second search agent 150 are similarly configured to include multiple search sub-agents 154, 156, 158. Moreover, it is to be understood that, for clarity, only three search sub-agents 154, 156, 158 are depicted. However, as indicated by the Nth search sub-agent 158, each search agent 148, 150, 152 of the multi-agent search and retrieval subsystem 140 may include any number of search sub-agents 154, 156, 158 and more search sub-agents 154, 156, 158 may be added as needed.

During operation of the structured multi-agent retrieval-augmented generation system 106, each search agent 148, 150, 152 is assigned a knowledge domain. Moreover, each search sub-agent 154, 156, 158 is assigned a knowledge sub-domain within a particular knowledge domain. For example, a particular knowledge domain may include “sports” and a one of the search agents 148, 150, 152 may be assigned to the knowledge domain under the heading “sports.” Further, the particular knowledge domain “sports” may include knowledge sub-domains, such as “baseball,” “football,” and “motorsports.” Accordingly, the search sub-agents 154, 156, 158 within the search agent 148, 150, 152 assigned to “sports” may each be assigned to “baseball,” “football,” and “motorsports,” respectively. As such, when a sports-related query 110 is received, the structured multi-agent retrieval-augmented generation system 106 can quickly assign the query 110 to the sports-related search agent 148, 150, 152. Further, if the query 110 is related to motorsports, the structured multi-agent retrieval-augmented generation system 106 can further assign the query 110 to the motorsports-related search sub-agent 154, 156, 158 within the sports-related search agent 148, 150, 152.

As shown, the query routing module 146 may also be operably coupled to the large language model subsystem 130 to provide the search agents 148, 150, 152 with direct access to the large language model 132. FIG. 1 further indicates that the multi-agent search and retrieval subsystem 140 may include an optimization module 160 coupled to each of the search agents 148, 150, 152 and a collaboration module 162 also coupled to each of the search agents 148, 150, 152.

As further depicted in FIG. 1, each of the search agents 148, 150, 152 are operably coupled, and have access, to a series of databases. As shown, the search agents 148, 150, 152 (and associated search sub-agents 154, 156, 158) are operably coupled, and have access, to a first database 170, a second database 172, and an Nth database 174. It is to be understood that three databases 170, 172, 174 are depicted for clarity. However, as indicated by the Nth database 174, the multi-agent search and retrieval subsystem 140, and the search agents 170, 172, 174 therein, may be operably coupled, and have access, to any number of databases. Further, while the databases 170, 172, 174 are indicated as being external to the structured multi-agent retrieval-augmented generation system 106, all of the databases 170, 172, 174 may be within the structured multi-agent retrieval-augmented generation system 106. Moreover, a portion of the databases 170, 172, 174 may be within the structured multi-agent retrieval-augmented generation system 106 and a portion of the databases 170, 172, 174 may be external to the structured multi-agent retrieval-augmented generation system 106.

It is to be understood that the structured multi-agent retrieval-augmented generation system 106 may operate on an information handling system, e.g., having an architecture according to one or more of the information handling systems described below. Further, the subsystems 120, 130, 140 may operate as part of information handling system on which the structured multi-agent retrieval-augmented generation system 106 operates. In such an embodiment, the subsystems 120, 130, 140 may include instructions that reside on the same memory within the information handling system on which the structured multi-agent retrieval-augmented generation system 106 operates. In another aspect, the subsystems 120, 130, 140 may include instructions that reside on the different memories within the information handling system on which the structured multi-agent retrieval-augmented generation system 106 operates.

Further, the subsystems 120, 130, 140 may include instructions that are executed by the same processor within the information handling system on which the structured multi-agent retrieval-augmented generation system 106 operates. Alternatively, the subsystems 120, 130, 140 may include instructions that are executed by different processors within the information handling system on which the structured multi-agent retrieval-augmented generation system 106 operates. In yet another embodiment, the subsystems 120, 130, 140 may operate on standalone information handling systems, e.g., each having an architecture according to one or more of the embodiments described below. These subsystems 120, 130, 140 will include their own memories in which instructions are stored and their own processors in which those instructions are executed. In any of the embodiments, the interconnectivity and interoperability will remain as described herein.

The structured multi-agent retrieval-augmented generation system 106 is configured to enhance the efficiency, accuracy, and scalability of traditional retrieval-augmented generation (RAG) models by introducing the multi-agent framework provided by the search agents 148, 150, 152. The search agents 148, 150, 152 are a series of specialized search agents and each search agent 148, 150, 152 is responsible for a specific knowledge domain. The search agents 148, 150, 152 may autonomously handle query processing within their designated areas to ensure that the right expertise is applied to each query. Further, each search agent 148, 150, 152 within the structured multi-agent retrieval-augmented generation system 106 is tailored to a specific category of knowledge, such as healthcare, finance, sports, technology, etc. The search agents 148, 150, 152 are equipped to retrieve and process relevant data from specialized sources, ensuring that the information is highly contextual and relevant to the query.

Once a search agent 148, 150, 152 identifies and processes the relevant information within its domain, it collaborates with other search agents 148, 150, 152, via the collaboration module 162, if necessary, to gather complementary insights before sending the results to the large language model 132. This distributed process reduces the burden on any single search agent 148, 150, 152 and enables a more nuanced approach to complex queries that span multiple knowledge areas. As described in greater detail below, the query routing module 146 of the structured multi-agent retrieval-augmented generation system 106 dynamically routes the query 110 to the appropriate search agents 148, 150, 152 based on the context and requirements of the query 110. This ensures that only the most relevant search agents 148, 150, 152 are engaged and reduces computational overhead and improving response times. Moreover, after the specialized search agents 148, 150, 152 gather and filter the relevant data, they pass the information to the large language model 132, which is used for final synthesis and natural language generation. The large language model 132 synthesizes and generates human-readable responses, backed by highly relevant and precise data, while minimizing the risk of hallucinations.

The multi-agent structure of the structured multi-agent retrieval-augmented generation system 106 allows for easy scalability. Sessions will be managed to ensure that sessions can be handed off between search agents 148, 150, 152 in the structured multi-agent retrieval-augmented generation system 106 as the conversation evolves and requires different expertise. New search agents 148, 150, 152 can be added as needed to address emerging domains of knowledge, and existing search agents 148, 150, 152 can be refined to improve performance in their specialized areas. This modular approach provides flexibility in adapting the structured multi-agent retrieval-augmented generation system 106 to new challenges or expanding its capabilities as knowledge domains grow. Further, the structured multi-agent retrieval-augmented generation system 106, disclosed herein, addresses the limitations of traditional retrieval-augmented generation systems by decentralizing the retrieval process using multiple search agents 148, 150, 152, enhancing domain-specific accuracy, and ensuring more efficient collaboration between the search agents 148, 150, 152 of the structured multi-agent retrieval-augmented generation system 106. This results in a robust, scalable solution for complex query processing across diverse domains.

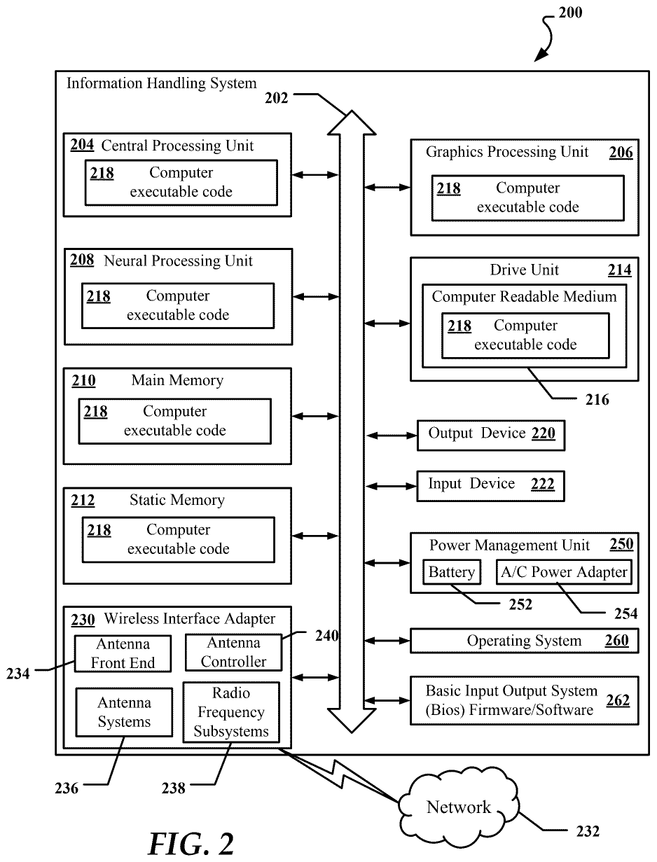

FIG. 2 illustrates an information handling system 200 having various components disposed therein. For purposes of this disclosure, the information handling system 200 may include any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, the information handling system 200 can be a personal computer, a mobile device (e.g., a personal digital assistant (PDA) or a smart phone), server (e.g., a blade server or a rack server), a consumer electronic information handling system, a network server or storage device, a network router, switch, or bridge, wireless router, or other network communication information handling system, a network connected device (cellular telephone, tablet information handling system, etc.), IoT computing device, wearable computing device (e.g., a smart watch or smart glasses), a set-top box (STB), a mobile device, a palmtop computer, a laptop computer, a desktop computer, a communications device, an access point (AP), a base station transceiver, a wireless telephone, a land-line telephone, a control system, a camera, a scanner, a facsimile machine, a printer, a pager, a personal device, a web appliance, or any other suitable machine capable of executing a set of instructions (sequential or otherwise) that specify actions to be taken by that machine, and can vary in size, shape, performance, price, and functionality.

In a networked deployment, for example, the information handling system 200 may operate in the capacity of a server or as a client computer in a server-client network environment, or as a peer computer system in a peer-to-peer (or distributed) network environment. In a particular embodiment, the information handling system 200 can be implemented using electronic information handling systems that provide voice, video or data communication. For example, an information handling system 200 may be any mobile or other computing device capable of executing a set of instructions (sequential or otherwise) that specify actions to be taken by that machine. Further, while a single information handling system 200 is illustrated, the term “system” shall also be taken to include any collection of systems or sub-systems that individually or jointly execute a set, or multiple sets, of instructions to perform one or more computer functions.

In general, the information handling system 200 can include memory (volatile (e.g., random-access memory, etc.), nonvolatile (read-only memory, flash memory etc.) or any combination thereof), one or more processing resources, such as a central processing unit (CPU), a graphics processing unit (GPU), a neural processing unit (N PU), hardware or software control logic, or any combination thereof. Additional components of the information handling system 200 can include one or more storage devices, one or more communications ports for communicating with external devices, as well as, various input and output (I/O) devices, such as a keyboard, a mouse, a video/graphic display, or any combination thereof. The information handling system 200 can also include one or more buses operable to transmit communications between the various hardware components. Portions of an information handling system 200 may themselves be considered information handling systems 200. The information handling system 200 can include devices or modules that embody one or more of the devices or execute instructions for the one or more systems and modules described herein, and operates to perform one or more of the methods described herein.

As illustrated in FIG. 2, in particular, the information handling system 200 can include one or more buses 202 operable to transmit communications between the various hardware components such as any combination of various input and output (I/O) devices described herein. The information handling system 200 can include one or more processors operably coupled to the bus 202. For example, the information handling system 200 can include a central processing unit (CPU) 204, a graphics processing unit (GPU) 206, a neural processing unit (NPU) 208, or any combination thereof. The CPU 204, the GPU 206, and the NPU 208 may include control logic and may individually, or collectively, operate to execute code that is either firmware or software code. Moreover, the information handling system 200 can include one or more memory devices such as a main memory 210, a static memory 212, and a drive unit 214 having a computer readable medium 216 disposed therein. The drive unit 214 can include a hard drive unit, a solid state drive unit, or a combination thereof. Further, the various memory devices 210, 212, 214, 216 may include volatile memory (e.g., random-access memory, etc.), nonvolatile memory (read-only memory, flash memory etc.) or any combination thereof).

The information handling system 200 includes computer executable code 218 that may reside on, or be executed by, the CPU 204, the GPU 206, the N PU 208, the main memory 210, the static memory 212, the computer readable medium 216 of the drive unit 214, or any combination thereof. The computer executable code 218 can include instructions (e.g., software algorithms), parameters, and profiles. The computer executable code 218 that may operate on servers or systems, remote data centers, or on-box in individual client information handling systems according to various embodiments herein. In some embodiments, it is understood any or all portions of the computer executable code 218 may operate on, or be executed by, the CPU 204, the GPU 206, the N PU 208, the main memory 210, the static memory 212, the computer readable medium 216 of the drive unit 214, or any combination thereof. In some embodiments, it is understood any or all portions of computer executable code 218 may operate on a plurality of information handling systems 200.

As shown, the information handling system 200 may further include an output device 220, e.g., a video display output. In an embodiment, the output device 220 may include a liquid crystal display (LCD), an organic light emitting diode (OLED), a flat panel display, a solid-state display, a curved panel display, a flexible panel display, or a combination thereof. Further, the output device 220 may include one or more sound output devices, e.g., speakers. As further illustrated, the information handling system 200 may include an input device 222 that may include an alpha numeric input device, such as a keyboard, and/or a cursor control device, such as a mouse, touchpad, or gesture or touch screen input device.

The information handling system 200 may also include a network interface device, shown as a wireless interface adapter 230, that can provide connectivity to a network 232, e.g., a wide area network (WAN), a local area network (LAN), wireless local area network (WLAN), a wireless personal area network (WPAN), a wireless wide area network (WWAN), or another network. In an embodiment, the WAN, WWAN, LAN, and WLAN may each include an access point used to operatively coupled the information handling system 200 to a network. In a specific embodiment, the network 254 may include macro-cellular connections via one or more base stations, one or more wireless access points (e.g., Wi-Fi or WIGig), one or more licensed or unlicensed WWAN small cell base stations, or a combination thereof. Further, network connectivity may be a wired or wireless connection.

As depicted, the wireless interface adapter 230 may include an antenna front end 234, one or more antenna systems 236, one or more radio frequency subsystems 238, and an antenna controller 240. These components may include transmitter/receiver circuitry, modem circuitry, one or more radio frequency front end circuits, one or more wireless controller circuits, amplifiers, and other circuitry of the wireless interface adapter, such as one or more antenna ports used for wireless communications via multiple radio access technologies. Each radio frequency subsystem 234 may communicate with one or more wireless technology protocols. The radio frequency subsystem 234 may contain individual subscriber identity module (SIM) profiles for each technology service provider and their available protocols for any operating subscriber-based radio access technologies such as cellular LTE communications.

In some embodiments of the present disclosure, the wireless interface adapter 230 may operate two or more wireless links. In a further embodiment, the wireless interface adapter 230 may operate the two or more wireless links with a single, shared communication frequency band such as with the 5G standard relating to unlicensed wireless spectrum for small cell 5G operation or for unlicensed Wi-Fi WLAN operation in an example embodiment. For example, a 2.4 GHz/2.5 GHz or 5 GHz wireless communication frequency bands may be apportioned under the 5G standards for communication on either small cell WWAN wireless link operation or Wi-Fi WLAN operation. In some embodiments, the shared, wireless communication band may be transmitted through one or a plurality of antennas or antennas may be capable of operating at a variety of frequency bands.

The wireless interface adapter 230 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, or similar wireless standards may be used. Wireless interface adapter 230 may connect to any combination of macro-cellular wireless connections including 2G, 2.5G, 3G, 4G, 5G or the like from one or more service providers. Utilization of radiofrequency communication bands according to several example embodiments of the present disclosure may include bands used with the WLAN standards and WWAN carriers which may operate in both licensed and unlicensed spectrums. For example, both WLAN and WWAN may use the Unlicensed National Information Infrastructure (U-NII) band which typically operates in the ~5MHz frequency band such as 802.11 a/h/j/n/ac/ax (e.g., center frequencies between 5.170-7.125 GHz). WLAN, for example, may operate at a 2.4 GHz band, 5 GHz band, and/or a 6 GHz band according to, for example, Wi-Fi, Wi-Fi 6, or Wi-Fi 6E standards. WWAN may operate in a number of bands, some of which are proprietary but may include a wireless communication frequency band. For example, low-band 5G may operate at frequencies similar to 4G standards at 600-850 MHz. Mid-band 5G may operate at frequencies between 2.5 and 3.7 GHz. Additionally, high-band 5G frequencies may operate at 25 to 39 GHz and even higher. In additional examples, WWAN carrier licensed bands may operate at the new radio frequency range 2 (NRFR1), NFRF2, bands, and other known bands. Each of these frequencies used to communicate over the network 254 may be based on the radio access network (RAN) standards that implement, for example, eN odeB or gN odeB hardware connected to mobile phone networks (e.g., cellular networks) used to communicate with the information handling system 200. In the example embodiment, mobile device 200 may also include both unlicensed wireless RF communication capabilities as well as licensed wireless RF communication capabilities. For example, licensed wireless RF communication capabilities may be available via a subscriber carrier wireless service operating the cellular networks. With the licensed wireless RF communication capability, a WWAN RF front end of the information handling system 200 may operate on a licensed WWAN wireless radio with authorization for subscriber access to a wireless service provider on a carrier licensed frequency band.

The wireless interface adapter 230 can represent an add-in card, wireless network interface module that is integrated with a main board of the information handling system or integrated with another wireless network interface capability, or any combination thereof. In an embodiment the wireless interface adapter 230 may include one or more radio frequency subsystems 230 including transmitters and wireless controllers for connecting via a multitude of wireless links. In an example embodiment, an information handling system may have an antenna system transmitter for 5G small cell WWAN, Wi-Fi WLAN or WiGig connectivity and one or more additional antenna system transmitters for macro-cellular communication. The radio frequency subsystems 230 include wireless controllers to manage authentication, connectivity, communications, power levels for transmission, buffering, error correction, baseband processing, and other functions of the wireless interface adapter 230.

The information handling system 200 may further include a power management unit (PM U) 250 (a.k.a. a power supply unit (PSU)). The PM U 250 may manage the power provided to the components of the information handling system 200, e.g., the CPU 204, the GPU 206, the NPU 208, the main memory 210, the static memory 212, the drive unit 214, the output device 220, the input device 222, the wireless interface adapter 230, any combination thereof, and any other components that may require power when a power button on the information handling system 200 is actuated by a user. In an embodiment, the PM U 250 may monitor power levels and be electrically coupled to the information handling system 200 to provide this power and coupled to bus 208 to provide or receive data or instructions. The PM U 250 may regulate power from a power source such as a battery 252 or A/C power adapter 254. In an embodiment, the battery 252 may be charged via the A/C power adapter 254 and provide power to the components of the information handling system 200 when A/C power from the A/C power adapter 254 is removed.

FIG. 2 further indicates that the information handling system 200 includes an operating system (OS) 260, a basic input/output system (BIOS) firmware/software 262, one or more application programs, or a combination thereof that may be part of the computer executable code 218 that is executed at the CPU 204, the GPU 206, the NPU 208, or a combination thereof, and stored the main memory 210, the static memory 212, the computer readable medium 216 of the drive unit 214, or any combination thereof. The BIOS firmware/software 262 functions to initialize information handling system 200 on power up, to launch the OS 260, and to manage input and output interactions between the OS 260 and the other elements of information handling system 200. In a particular embodiment, BIOS firmware/software 262 resides in the main memory 208 or the static memory 212, and includes machine-executable code that is executed by the CPU 204 to perform various functions of information handling system 200 as described herein. In another embodiment (not illustrated), application programs and BIOS firmware/software 262 can reside in another storage medium of information handling system 200. For example, application programs and BIOS firmware/software 262 can reside in the drive unit 214, in a ROM (not illustrated) associated with information handling system 200, in an option-ROM (not illustrated) associated with various devices of information handling system 200, in a storage system (not illustrated) associated with network channel of the wireless interface adapter 230, in another storage medium of information handling system 200, or a combination thereof. It is to be understood that computer executable code 218 for application programs and BIOS firmware/software 238 can each be implemented as single programs, or as separate programs carrying out the various features as described herein.

As stated above, the information handling system 200 may connect to the external wireless network 232. In particular, the wireless network 232 may have a wireless mesh architecture in accordance with mesh networks described by the wireless data communications standards or similar standards in some embodiments but not necessarily in all embodiments. The wireless interface adapter 230 may connect to the external wireless network 233 via a WPAN, WLAN, WWAN or similar wireless switched Ethernet connection in some embodiments. The wireless data communication standards set forth protocols for communications and routing via access points, as well as protocols for a variety of other operations. Other operations may include handoff of client devices moving between nodes, self-organizing of routing operations, or self-healing architectures in case of interruption.

In some embodiments, software, firmware, dedicated hardware implementations such as application specific integrated circuits, programmable logic arrays and other hardware information handling systems can be constructed to implement one or more of the methods described herein. Applications that may include the apparatus and systems of various embodiments can broadly include a variety of electronic and computer systems. One or more embodiments described herein may implement functions using two or more specific interconnected hardware modules or information handling systems with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software programs executable by a controller or a processor system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 216 that includes computer executable code 218 (e.g., instructions, parameters, and profiles), or receives and executes computer executable code 218 (e.g., instructions, parameters, and profiles) responsive to a propagated signal; so that a device connected to the wireless network 232 can communicate voice, video or data over the wireless network 232. Further, the computer executable code 218 may be transmitted or received over the wireless network 232 via the network interface device, i.e., the wireless interface adapter 230.

The wireless interface adapter 230 represents a network interface card (NIC) disposed within information handling system 200, on a main circuit board of the information handling system 200, integrated onto another component such as the CPU 204, in another suitable location, or a combination thereof. The wireless interface adapter 230 can include another information handling system, a data storage system, another network, a grid management system, another suitable resource, or a combination thereof. In an embodiment, the wireless interface adapter 230 may operably connect to the network 232. The connection to network 232 may be wired or wireless.

The network interface device shown as wireless interface adapter 230 can provide connectivity to the network 232, such as a wide area network (WAN), a local area network (LAN), wireless local area network (WLAN), a wireless personal area network (WPAN), a wireless wide area network (WWAN), or another network. Connectivity may be via wired or wireless connection. The wireless interface adapter 230 may include an adaptive massive MIMO Multiplexer with transmitter/receiver circuitry, wireless controller circuitry, amplifiers and other circuitry for wireless communications. The wireless interface adapter 230 may also include antenna systems 236 as described above which may be tunable antenna systems for use with the system and methods disclosed in the embodiments herein. The antenna controller 240 may also include wireless controllers to manage authentication, connectivity, communications, power levels for transmission, buffering, error correction, baseband processing, and other functions of the wireless interface adapter 230.

The information handling system 200 can include a set of computer executable code 218 that can be executed to cause the information handling system 200 to perform any one or more of the methods or computer-based functions disclosed herein. For example, computer executable code 218 may execute various software applications, software search agents, or other aspects or components. Various software modules comprising application computer executable code 218 may be coordinated by the OS 260, and/or via an application programming interface (API). An example operating system may include Windows ®, Android ®, and other OS types known in the art. Example A Pls may include Win 32, Core Java API, or Android A Pls.

The drive unit 214 may include a computer-readable medium 216 in which one or more sets of computer executable code 218 such as software can be embedded to be executed by the CPU 204, the GPU 206, the NPU 208, or a combination thereof, to perform the processes described herein. Similarly, main memory 204 and static memory 206 may also contain a computer-readable medium for storage of one or more sets computer executable code 218 (e.g., instructions, parameters, or profiles). The drive unit 214 or static memory 212 also contain space for data storage. Further, the computer executable code 218 may embody one or more of the methods or logic as described herein. In a particular embodiment, the computer executable code 218 may reside completely, or at least partially, within the main memory 204, the static memory 206, and/or within the disk drive 216 during execution by the CPU 204 of the information handling system 200. The CPU 204, the GPU 206, and the NPU 208 also may include computer-readable media. The NPU 208 may include computer executable code 218 that includes an artificial intelligence (AI) application security module.

The main memory 208, the static memory 212, or other memory of the embodiments described herein may contain computer-readable medium (not shown), such as RAM. An example of main memory 208 can include random access memory (RAM) such as static RAM (SRAM) , dynamic RAM (DRAM), non-volatile RAM (NV-RAM) , or the like, read only memory (ROM) , another type of memory, or a combination thereof. The static memory 212 may contain computer-readable medium (not shown), such as NOR or NAND flash memory in some example embodiments. The drive unit 214 may include access to a computer-readable medium 216 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In other embodiments, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

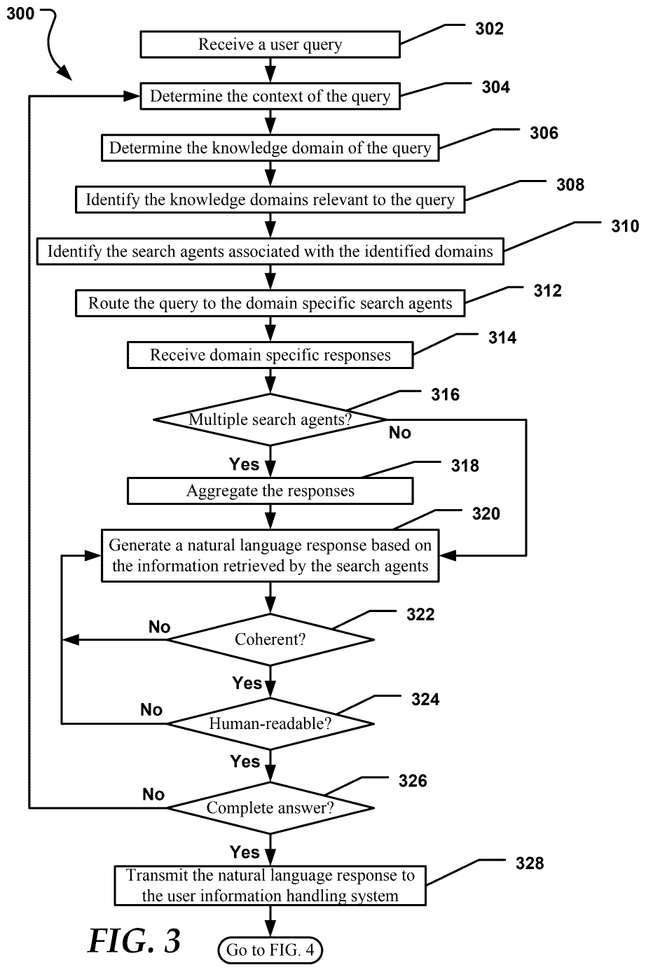

FIG. 3 illustrates a flow diagram of a method 300 of using artificial intelligence to prioritize security risks in a software development system. The method 300 may be performed, for example, in an information handling system that is configured according to at least one embodiment of an information handling system that is described in the present disclosure and the method 300 commences at block 302. It will be readily appreciated that not every method step set forth in this flow diagram is always necessary, and that certain steps of the methods may be combined, performed simultaneously, in a different order, or perhaps omitted, without varying from the scope of the disclosure. The method steps depicted in FIG. 3 may be executed, or employed in whole, or in part, by any of the processors disclosed herein, any other type of controller, device, module, processor, or any combination thereof, operable to employ, or otherwise execute, all, or portions of, the method 300 of FIG. 3.

Beginning at block 302, the method 300 includes receiving a user query 110. In particular, the user query 110 is receive in natural language. Then, at blocks 304 and 306, the query 110 is processed. For example, at block 304, the method 300 includes processing the query 110 to determine the context of the query 110 and at block 306, the method 300 includes further processing the query 110 to determine the knowledge domain of the query 110. These actions may be performed using the simple classifier 142 to identify the domain of the query 110, e.g., healthcare, finance, technology, sports, etc., and extract keywords or semantic components from the query 110 using natural language processing (NLP) techniques to determine the context.

At block 308, the method 300 may include identifying the knowledge domains relevant to the query, e.g., the processed query. Specifically, the domain classifier 144 may identify the knowledge domains relevant to the query. For example, if the processed query contains terms like “patient,” “disease,” “medication,” etc., the knowledge domain is classified as “Healthcare.” Further, if the processed query includes terms like “stock,” “market,” “investment,” etc., the knowledge domain is classified as “Finance.” Other knowledge domains are similarly identified. Further, relevant knowledge sub-domains may be identified within a particular knowledge domain.

Moving to block 310, the method 300 may include identifying the specific search agent, or search agents, associated with the specific knowledge domains identified above. Moreover, search sub-agents within a particular agent, or agents, may be identified. At block 312, the method 300 may include routing the query to the knowledge domain specific search agents and search sub-agents, when appropriate. Each search agent 148, 150, 152 is responsible for a specific knowledge domain and each search sub-agent 154, 156, 158 within a particular agent 148, 150, 152 is responsible for a specific knowledge sub-domain within a particular knowledge domain. For example, a healthcare search agent handles healthcare-related queries and retrieves relevant information from medical databases or research articles. Similarly, a finance search agent processes finance-related queries using financial data sources and models.

Continuing to block 314, the method 300 includes receiving knowledge domain specific responses from the search agent, or search agents. Sub-domain responses may also be received from search sub-agents. Each response includes one or more data points related to the query that is retrieved by a respective search agent, or search sub-agent, from a specific database. At block 316, the method 300 includes determining whether multiple search agents have returned responses. If so, the method 300 may move to block 318 and the method 300 may include aggregating the responses. Then, the method 300 may move to block 320. Returning to decision 316, if only a single search agent returns a response, the method 300 may skip the aggregation step at block 318 and them method 300 may move directly to block 320. At block 320, the method 300 may include generating a natural language response 112 based on the information retrieved from the search agent, or search agents. The natural language response 112 may be generated by the large language model 132.

Moving to decision 322, the method 300 may include determining whether the natural language response 112 is coherent. If the natural language response 112 is not coherent, the method 300 may return to block 320 and a new natural language response 112 may be generated. Thereafter, the method 300 may continue as shown and described herein. At decision 322, if the natural language response 112 is coherent, the method 300 may proceed to decision 324 and the method 300 may determine whether the natural language response 112 is human-readable. If the natural language response 112 is not human-readable, the method 300 may return to block 320 and a new natural language response 112 may be generated. Then, the method 300 may continue as described herein.

At decision 324, if the natural language response 112 is human-readable, the method 300 may proceed to decision 326. At decision 326, the method 300 may determine whether the natural language response 112 is a complete response to the user query 110. If the natural language response 112 is not a complete response to the user query 110, the method 300 may return to block 304 and essentially start over. Then, the method 300 may continue as described herein. On the other hand, at decision 326, if the natural language response 112 is a complete response to the user query 110, the method 300 proceeds to block 328. At block 328, the method 300 may include transmitting the natural language response 112 to a user device, e.g., the user information handling system 102 and the chatbot user interface 108 thereon.

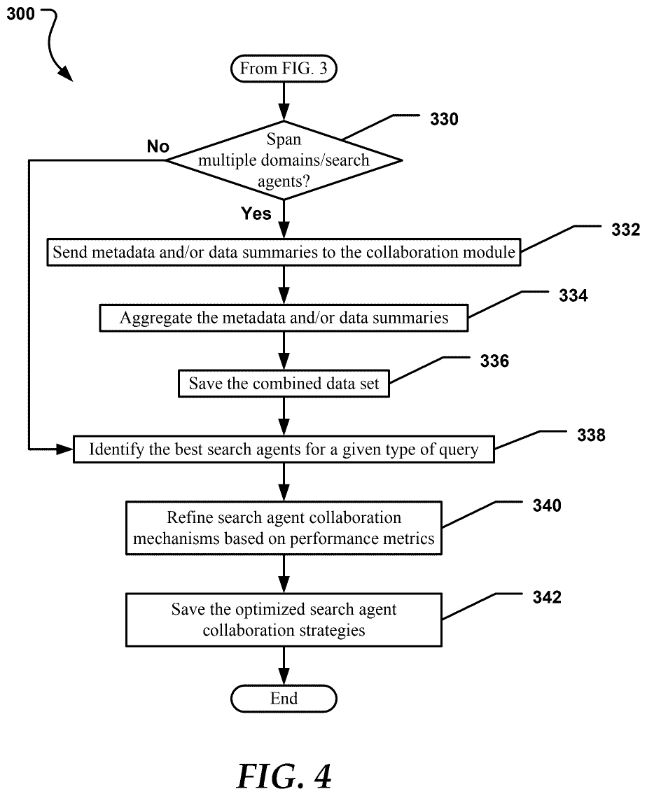

From block 328, the method 300 may proceed to decision 330 of FIG. 4. At decision 330, the method 300 may determine whether the results determined above spanned multiple domains (and sub-domains) and/or multiple search agents (and search sub-agents). For example, if the query spans multiple domains (e.g., healthcare and finance), the search agents that were used to retrieve the information can collaborate to provide more efficient data retrieval for future queries. Specifically, the search agents (and sub-agents) involved can exchange information to combine insights. For example, the Healthcare search agent might need financial information to address the cost of treatment. This is achieved via steps 332 through 336. At block 332 and the method 300 may include sending metadata and/or data summaries to the collaboration module. For example, the search agents 148, 150, 152 send metadata or data summaries to the collaboration module. Then, the method 300 may proceed to block 334 and the method 300 may include aggregating the metadata and/or data summaries. The collaboration module may aggregate the metadata and/or data summaries. At block 336, the method 300 may include saving the combined data set, e.g., at the collaboration module. Thereafter, the method 300 may proceed to block 338.

Returning to decision 330, if the results determined above did not span multiple domains (and sub-domains) and/or multiple search agents (and search sub-agents), the method 300 may proceed directly to block 338. At block 338, using machine learning for example, the method 300 may include identify the best search agents (and when appropriate, search sub-agents) for a given type of query. This serves to enhance routing decisions for future queries. Further, at block 340, the method 300 may optimize, or otherwise refine, search agent collaboration mechanisms based on performance metrics, e.g., accuracy of results, efficiency in the retrieval of the results, speed in the retrieval of the results, etc. Finally, at block 342, the method 300 may include saving the optimized search agent collaboration strategies to be used for future queries when relevant. Thereafter, the method 300 may end.

It is to understood that the first part of the method 300 depicted in FIG. 3, i.e., step 302 through step 328, includes the natural language response generation portion. Further, the second part of the method 300 depicted in FIG. 4, i.e., step 330 through step 342, is the optimization portion. The optimization portion is essentially a continuous feedback that is performed after every query is received to optimize the search agents that are used for various queries. This serves to enhance the user experience by limiting the likelihood of returning bad information, aka, hallucinations. Further, the continuous feedback can enhance the user experience by increasing the speed at which the natural language responses 112 are returned to the user.

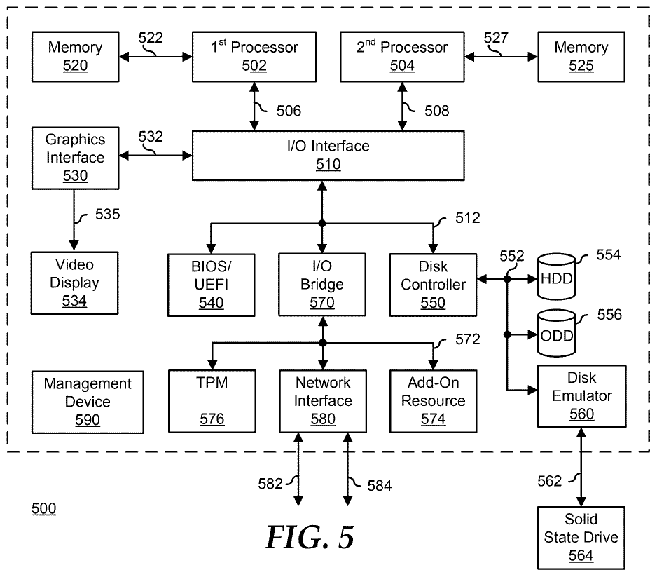

FIG. 5 shows a generalized embodiment of an information handling system 500 according to an embodiment of the present disclosure. Information handling system 500 may be substantially similar to the information handling system 100 of FIG. 1. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 500 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 500 can include processing resources for executing machine-executable code, such as a central processing unit (CPU), a programmable logic array (PLA) , an embedded device such as a System-on-a-Chip (SoC), or other control logic hardware. Information handling system 500 can also include one or more computer-readable medium for storing machine-executable code, such as software or data. Additional components of information handling system 500 can include one or more storage devices that can store machine-executable code, one or more communications ports for communicating with external devices, and various input and output (I/O) devices, such as a keyboard, a mouse, and a video display. Information handling system 500 can also include one or more buses operable to transmit information between the various hardware components.

Information handling system 500 can include devices or modules that embody one or more of the devices or modules described below and operates to perform one or more of the methods described herein. Information handling system 500 includes a processors 502 and 504, an input/output (I/O) interface 510, memories 520 and 525, a graphics interface 530, a basic input and output system/universal extensible firmware interface (BIOS/UEFI) module 540, a disk controller 550, a hard disk drive (HDD) 554, an optical disk drive (ODD) 556, a disk emulator 560 connected to an external solid state drive (SSD) 564, an I/O bridge 570, one or more add-on resources 574, a trusted platform module (TPM) 576, a network interface 580, a management device 590, and a power supply 595. Processors 502 and 504, I/O interface 510, memory 520, graphics interface 530, BIOS/UEFI module 540, disk controller 550, HDD 554, ODD 556, disk emulator 560, SSD 564, I/O bridge 570, add-on resources 574, TPM 576, and network interface 580 operate together to provide a host environment of information handling system 500 that operates to provide the data processing functionality of the information handling system. The host environment operates to execute machine-executable code, including platform BIOS/UEFI code, device firmware, operating system code, applications, programs, and the like, to perform the data processing tasks associated with information handling system 500.

In the host environment, processor 502 is connected to I/O interface 510 via processor interface 506, and processor 504 is connected to the I/O interface via processor interface 508. Memory 520 is connected to processor 502 via a memory interface 522. Memory 525 is connected to processor 504 via a memory interface 527. Graphics interface 530 is connected to I/O interface 510 via a graphics interface 532 and provides a video display output 536 to a video display 534. In a particular embodiment, information handling system 500 includes separate memories that are dedicated to each of processors 502 and 504 via separate memory interfaces. An example of memories 520 and 525 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 540, disk controller 550, and I/O bridge 570 are connected to I/O interface 510 via an I/O channel 512. An example of I/O channel 512 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 510 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 540 includes BIOS/UEFI code operable to detect resources within information handling system 500, to provide drivers for the resources, initialize the resources, and access the resources. BIOS/UEFI module 540 includes code that operates to detect resources within information handling system 500, to provide drivers for the resources, to initialize the resources, and to access the resources.

Disk controller 550 includes a disk interface 552 that connects the disk controller to HDD 554, to ODD 556, and to disk emulator 560. An example of disk interface 552 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 560 permits SSD 564 to be connected to information handling system 500 via an external interface 562. An example of external interface 562 includes a USB interface, an IEEE 5394 (Firewire) interface, a proprietary interface, or a combination thereof. Alternatively, solid-state drive 564 can be disposed within information handling system 500.

I/O bridge 570 includes a peripheral interface 572 that connects the I/O bridge to add-on resource 574, to TPM 576, and to network interface 580. Peripheral interface 572 can be the same type of interface as I/O channel 512 or can be a different type of interface. As such, I/O bridge 570 extends the capacity of I/O channel 512 when peripheral interface 572 and the I/O channel are of the same type, and the I/O bridge translates information from a format suitable to the I/O channel to a format suitable to the peripheral channel 572 when they are of a different type. Add-on resource 574 can include a data storage system, an additional graphics interface, a network interface card (NIC), a sound/video processing card, another add-on resource, or a combination thereof. Add-on resource 574 can be on a main circuit board, on separate circuit board or add-in card disposed within information handling system 500, a device that is external to the information handling system, or a combination thereof.

Network interface 580 represents a NIC disposed within information handling system 500, on a main circuit board of the information handling system, integrated onto another component such as I/O interface 510, in another suitable location, or a combination thereof. Network interface device 580 includes network channels 582 and 584 that provide interfaces to devices that are external to information handling system 500. In a particular embodiment, network channels 582 and 584 are of a different type than peripheral channel 572 and network interface 580 translates information from a format suitable to the peripheral channel to a format suitable to external devices. An example of network channels 582 and 584 includes InfiniBand channels, Fibre Channel channels, Gigabit Ethernet channels, proprietary channel architectures, or a combination thereof. Network channels 582 and 584 can be connected to external network resources (not illustrated). The network resource can include another information handling system, a data storage system, another network, a grid management system, another suitable resource, or a combination thereof.

Management device 590 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 500. In particular, management device 590 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 500, such as system cooling fans and power supplies. Management device 590 can include a network connection to an external management system, and the management device can communicate with the management system to report status information for information handling system 500, to receive BIOS/UEFI or system firmware updates, or to perform other task for managing and controlling the operation of information handling system 500.

Management device 590 can operate off of a separate power plane from the components of the host environment so that the management device receives power to manage information handling system 500 when the information handling system is otherwise shut down. An example of management device 590 include a commercially available BMC product or other device that operates in accordance with an Intelligent Platform Management Initiative (IPMI) specification, a Web Services Management (WSM an) interface, a Redfish Application Programming Interface (API), another Distributed Management Task Force (DMTF), or other management standard, and can include an Integrated Dell Remote Access Controller (IDRAC), an Embedded Controller (EC), or the like. Management device 590 may further include associated memory devices, logic devices, security devices, or the like, as needed, or desired.

The system and methods described herein provides a structured multi-agent retrieval-augmented generation system 106 that can be used to provide more accurate and faster natural language responses in response to user queries received via a chatbot. The structured multi-agent retrieval-augmented generation system 106 leverages a structured network of specialized search agents, each responsible for a distinct domain of knowledge. The search agents independently retrieve, process, and refine information before selectively engaging with the large language model 132 to generate accurate and contextually relevant responses.

The structured multi-agent retrieval-augmented generation system 106 employs intelligent routing mechanisms, e.g., the query routing module 146, to ensure that queries are directed to the most relevant search agents 148, 150, 152, improving retrieval efficiency and reducing hallucinations. Each search agent 148, 150, 152 operates within its predefined knowledge scope, leveraging optimized retrieval strategies and, when necessary, interacting with the large language model for contextual synthesis. This structured approach enhances modularity, scalability, and adaptability in the structured multi-agent retrieval-augmented generation system 106, making it particularly useful for enterprise applications, compliance-driven environments, and domain-specific knowledge retrieval.

By decentralizing retrieval responsibilities and enabling domain-aware knowledge augmentation, the structured multi-agent retrieval-augmented generation system 106 significantly enhances response accuracy, reduces computational overhead, and provides a more explainable and controllable framework for AI-driven information retrieval and generation. For example, in the structured multi-agent retrieval-augmented generation system 106, the query 110 may be routed to a specialized search agent 148, 150, 152, thus reducing the scope of the data that the search agent 148, 150, 152. Aggregated results from the structured multi-agent retrieval-augmented generation system 106 are more accurate because each search agent 148, 150, 152 handles only a subset of knowledge, ensuring that the response is highly relevant to the domain-specific needs of the query 110.

Further, in the structured multi-agent retrieval-augmented generation system 106, the query 110 may be routed to a specialized search agent 148, 150, 152 based on the domain identified in the query 110 and therefore, significantly reduces the search space. Therefore, the efficiency is improved by decentralizing the retrieval process. Specifically, the structured multi-agent retrieval-augmented generation system 106 improves both accuracy and efficiency. The decentralization of the retrieval process provided by the structured multi-agent retrieval-augmented generation system 106 allows domain-specific search agents 148, 150, 152 to process queries more effectively, leading to higher accuracy by reducing the irrelevant information retrieved. The routing mechanism of the structured multi-agent retrieval-augmented generation system 106 also enhances scalability and performance by reducing the computational overhead of accessing large, centralized databases.

For more complex queries 110, the structured multi-agent retrieval-augmented generation system 110 may split the query 110 split and route the query to multiple search agents 148, 150, 152, and each search agent 148, 150, 152 may handle a domain-specific subset of the data, reducing the time complexity per query. By routing queries 110 to domain-specific search agents 148, 150, 152, the structured multi-agent retrieval-augmented generation system 106 reduces the scope of the search and enhances both accuracy (by focusing on relevant knowledge) and time efficiency (by reducing the number of operations needed).

The structured multi-agent retrieval-augmented generation system 106 is configured to handle increasing numbers of queries or growing knowledge bases more effectively, as the time complexity scales linearly with the size of each domain-specific knowledge base rather than with the size of the entire central database. As stated elsewhere herein, instead of relying on a single retrieval mechanism, the structured multi-agent retrieval-augmented generation system 106 distributes query processing across multiple domain-specific search agents 148, 150, 152 and each search agents 148, 150, 152 is responsible for a specialized knowledge area. The decentralized, or distributed approach, provided by the structured multi-agent retrieval-augmented generation system 106 eliminates retrieval bottlenecks, enhances response accuracy, and allows for more scalable and modular query resolution.

The search agents 148, 150, 152 may autonomously recognize their relevance to a given query 110 through a semantic parsing and classification mechanism. Unlike static routing, this self-identification system enables search agents 148, 150, 152 to decide when and how to contribute, ensuring efficient knowledge retrieval across multiple domains without redundant processing.

Moreover, the structured multi-agent retrieval-augmented generation system 106 includes an inter-agent collaboration framework that enables multiple search agents 148, 150, 152 to refine and enrich responses collectively. The search agents 148, 150, 152 may exchange partial insights, ensuring that responses are synthesized from multiple domain perspectives. This framework reduces knowledge silos and enhances the system's ability to process multi-faceted queries more accurately than a single, generalized model. Additionally, the structured multi-agent retrieval-augmented generation system 106 may prioritize knowledge sources dynamically based on the complexity of a query. The queries can be resolved through direct search agent 148, 150, 152 knowledge retrieval, localized large language model inference, or cross-agent synthesis. The adaptive retrieval layering provided by the structured multi-agent retrieval-augmented generation system 106 optimizes efficiency by ensuring that computationally expensive large language model queries are only invoked when necessary.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

1. A system, comprising:
a memory configured to store a plurality of knowledge domain search agents, wherein each knowledge domain search agent is assigned to a particular knowledge domain; and
a processor to execute the plurality of knowledge domain search agents, the processor configured to:
receive a user query;
prioritize the knowledge domain search agents based on a complexity of the user query;
based on the prioritization of the knowledge domain search agents, route the user query to one or more of the plurality of knowledge domain search agents; and
perform a continuous feedback after every user query to optimize the plurality of knowledge domain search agents.

2. The system of claim 1, the processor further to:
receive one or more knowledge domain specific responses from the one or more knowledge domain search agents to which the user query is routed.

3. The system of claim 2, the processor further to:
generate a natural language response based on the one or more knowledge domain specific responses.

4. The system of claim 3, the processor further to:
transmit the natural language response to a user device.

5. The system of claim 1, the processor further to:
determine a context of the user query to extract keywords from the query.

6. The system of claim 5, the processor further to:
determine a knowledge domain of the user query based on the context.

7. The system of claim 6, the processor further to:
route the user query based on knowledge domain of the user query.

8. The system of claim 1, the processor further to:
save metadata and data summaries from multiple search agents after multiple search agents receive the user query and return knowledge domain specific responses.

9. A method of structured multi-agent retrieval-augmented generation, the method including:
receiving a user query;
determining a knowledge domain of the user query;
identifying one or more knowledge domain search agents from a group of search agents based on the knowledge domain;
prioritizing the knowledge domain search agents based on a complexity of the user query;
routing the user query to one or more identified search agents based on the prioritizing of the knowledge domain search agents; and
perform a continuous feedback after every user query to optimize the knowledge domain search agents.

10. (canceled)

11. The method of claim 9, further comprising:
receiving one or more knowledge domain specific responses from the one or more identified search agents.

12. The method of claim 11, further comprising:
aggregating multiple knowledge domain specific responses received from multiple identified search agents.

13. The method of claim 12, further comprising:
generating a natural language response based on the knowledge domain specific responses.

14. The method of claim 13, further comprising:
applying one or more quality control metrics to the natural language response.

15. The method of claim 14, further comprising:
transmitting the natural language response to a user device.

16. The method of claim 9, further comprising:
identifying search agent collaborations for future user queries.

17. The method of claim 16, further comprising:
optimizing search agent collaborations based on one or more performance metrics.

18. A system, comprising:
a memory including a plurality of knowledge domain search agents residing thereon, each search agent having a plurality of search sub-agents, wherein each knowledge domain search agent is assigned to a particular knowledge domain and each search sub-agent is assigned to a particular knowledge sub-domain within the particular knowledge domain; and
a processor operably coupled to the memory to execute the plurality of knowledge domain search agents, the processor to:
receive a user query;
determine a knowledge domain, a knowledge sub-domain, or a combination thereof for the user query;
prioritize the knowledge domain search agents based on a complexity of the user query;
based on the prioritization of the knowledge domain search agents, route the user query to one or more of the plurality of knowledge domain search agents, one or more of the search sub-agents, or a combination thereof; and
perform a continuous feedback after every user query to optimize the plurality of knowledge domain search agents.

19. The system of claim 18, the processor further to:
receive one or more knowledge domain specific responses, one or more knowledge sub-domain specific responses, or a combination thereof from the one or more search agents, the one or more search sub-agents, or a combination thereof to which the user query is routed.

20. The system of claim 19, the processor further to:
generate a natural language response based on the one or more knowledge domain specific responses, the one or more knowledge sub-domain specific responses, or a combination thereof; and
transmit the natural language response to a user device.
